(19) United States
(12) Patent Application Publication
(10) Pub. No.: US 2013/0120416 A1
(43) Pub. Date: May 16, 2013

(54) STORAGE CAPACITOR FOR ELECTROMECHANICAL SYSTEMS AND METHODS OF FORMING THE SAME

(71) Applicants: Jae Hyeong Seo, Pleasanton, CA (US); Ming-Hau Tung, San Francisco, CA (US); Marc M. Mignard, San Jose, CA (US)

(72) Inventors: Jae Hyeong Seo, Pleasanton, CA (US); Ming-Hau Tung, San Francisco, CA (US); Marc M. Mignard, San Jose, CA (US)

(73) Assignee: QUALCOMM MEMS Technologies, Inc., San Diego, CA (US)

(21) Appl. No.: 13/301,539

(22) Filed: Nov. 21, 2011

Related U.S. Application Data
(60) Provisional application No. 61/558,657, filed on Nov. 11, 2011.

(51) Int. Cl. G06F 13/14; G02B 26/00; H01G 7/00

(52) U.S. Cl. 345/520; 29/25.42; 359/290

(57) ABSTRACT

This disclosure provides systems, methods and apparatus for storage capacitors. In one aspect, an electromechanical systems (EMS) device includes a substrate, an optical stack disposed over the substrate, a mechanical layer positioned over the optical stack, and a storage capacitor. The optical stack includes a stationary electrode and at least one dielectric layer disposed over the stationary electrode, and the storage capacitor includes a first plate, a second plate and a dielectric structure disposed between the first and second plates. The first plate includes a portion of the mechanical layer positioned over an optically non-active region of the device, and the dielectric structure of the storage capacitor includes a portion of the at least one dielectric layer of the optical stack.

### CROSS-REFERENCE TO RELATED APPLICATIONS

The disclosure claims priority to U.S. Provisional Patent Application No. 61/558,657 filed Nov. 11, 2011 entitled “STORAGE CAPACITOR FOR ELECTROMECHANICAL SYSTEMS AND METHODS OF FORMING THE SAME,” which is assigned to the assignee hereof. The disclosure of the prior application is considered part of, and is incorporated by reference in, this disclosure.

### TECHNICAL FIELD

This disclosure relates to electromechanical systems.

### DESCRIPTION OF THE RELATED TECHNOLOGY

Electromechanical systems (EMS) include devices having electrical and mechanical elements, actuators, transducers, sensors, optical components (including mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography and/or other micromachining processes that etch away parts of substrates and/or deposited material layers, or that add layers to form electrical and electromechanical devices.

One type of EMS device is called an interferometric modulator (IMOD). As used herein, the term interferometric modulator or interferometric light modulator refers to a device that selectively absorbs and/or reflects light using the principles of optical interference. In some implementations, an IMOD may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the IMOD. IMOD devices have a wide range of applications, and are anticipated to be used in improving existing products and creating new products, especially those with display capabilities.

In an EMS device, the reflective membrane can be moved between an actuated position and a relaxed position by application of a voltage between an electrode coupled to the reflective membrane and a stationary electrode. However, charge leakage from the movable reflective membrane can impact the performance of the EMS device. For example, the refresh rate of the device can be affected by charge leakage. Accordingly, there is a need for reducing the impact of charge leakage and for improving the operational performance of EMS devices.

### SUMMARY

The systems, methods and devices of the disclosure each have several innovative aspects, no single one of which is solely responsible for the desirable attributes disclosed herein.

One innovative aspect of the subject matter described in this disclosure can be implemented in an electromechanical systems (EMS) device including a substrate, an optical stack disposed over the substrate, a movable layer and a storage capacitor. The optical stack includes a stationary electrode and at least one dielectric layer disposed over the stationary electrode. The movable layer is positioned over the optical stack to define a cavity between the movable layer and the optical stack, and the movable layer is movable through the cavity between an actuated position and a relaxed position. The storage capacitor includes a first plate, a second plate and a dielectric structure disposed between the first and second plates. The first plate includes a portion of the movable layer positioned over an optically non-active region of the device, and the dielectric structure of the storage capacitor includes a portion of the at least one dielectric layer of the optical stack.

In some implementations, the portion of the movable layer that forms the first plate of the capacitor contacts the at least one dielectric layer of the optical stack over the optically non-active region of the device.

In some implementations, the stationary electrode extends beneath the patterned portion of the support structure to define the second plate of the capacitor.

Another innovative aspect of the subject matter described in this disclosure can be implemented in a method of forming an EMS device having an actuated position and a relaxed position. The method includes forming an optical stack over a substrate, the optical stack including a stationary electrode and at least one dielectric layer disposed over the stationary electrode. The method further includes forming a movable layer over the optical stack and forming a storage capacitor including a first plate, a second plate and a dielectric structure disposed between the first and second plates. A portion of the movable layer over an optically non-active region of the device is arranged to form the first plate of the capacitor, and the at least one dielectric structure of the optical stack is arranged to form the dielectric layer of the capacitor.

In some implementations, the method further includes attaching the portion of the movable layer that forms the first plate of the capacitor to the at least one dielectric layer of the optical stack over the optically non-active region of the device.

In some implementations, the movable layer includes a reflective layer, a dielectric layer and a cap layer, the dielectric layer disposed between the reflective layer and the cap layer, and the portion of the movable layer that forms the first plate includes the reflective layer.

Another innovative aspect of the subject matter described in this disclosure can be implemented in an EMS device including a substrate, an optical stack disposed over the substrate, a movable layer and a means for storing charge including a first plate, a second plate and a dielectric structure disposed between the first and second plates. The optical stack includes a stationary electrode and at least one dielectric layer disposed over the stationary electrode. The movable layer is movable through the cavity between an actuated position and a relaxed position. The storing charge means is disposed in an optically non-active region of the device, and the storing charge means includes a portion of the movable layer and a portion of the at least one dielectric layer.

In some implementations, the charge storing means has a capacitance in the range of 10 fF to about 1,000 fF.

Details of one or more implementations of the subject matter described in this specification are set forth in the accompanying drawings and the description below. Although the examples provided in this disclosure are primarily described in terms of electromechanical systems (EMS) and microelectromechanical systems (MEMS)-based displays, the concepts provided herein may apply to other types of displays, such as liquid crystal displays, organic light-emitting diode (“OLED”) displays and field emission displays. Other features, aspects and advantages will become apparent from the description, the drawings and the claims. Note that the relative dimensions of the following figures may not be drawn to scale.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 IMOD display.

FIG. 3 shows an example of a diagram illustrating movable reflective layer position versus applied voltage for an IMOD of FIG. 1.

FIG. 4 shows an example of a table illustrating various states of an IMOD when various common and segment voltages are applied.

FIG. 5A shows an example of a diagram illustrating a frame of display data in the 3×3 IMOD display of FIG. 2.

FIG. 5B shows an example of a timing diagram for common and segment signals that may be used to write the frame of display data illustrated in FIG. 5A.

FIG. 6A shows an example of a partial cross-section of the IMOD display of FIG. 1.

FIGS. 6B-6E show examples of cross-sections of varying implementations of IMODs.

FIG. 7 shows an example of a flow diagram illustrating a manufacturing process for an IMOD.

FIGS. 8A-8E show examples of cross-sectional schematic illustrations of various stages in a method of making an IMOD.

FIG. 9 shows a circuit diagram for one example of an active-matrix IMOD array.

FIGS. 10A-10H show examples of cross-sectional schematic illustrations of various stages in methods of making active-matrix IMODs according to various implementations.

FIGS. 11A and 11B show examples of cross-sectional schematic illustrations of varying implementations of active-matrix electromechanical systems (EMS) devices.

FIG. 12 shows a schematic plan view of one example of an active-matrix EMS device.

FIG. 13 shows an example of a flow diagram illustrating a manufacturing process for an active-matrix EMS device.

FIGS. 14A and 14B show examples of system block diagrams illustrating a display device that includes a plurality of IMODs.

Like reference numbers and designations in the various drawings indicate like elements, which may have certain structural or characteristic differences according to certain implementations.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device or system that can be configured to display an image, whether in motion (e.g., video) or stationary (e.g., still image), and whether textual, graphical or pictorial. More particularly, it is contemplated that the described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (i.e., e-readers), computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS), microelectromechanical systems (MEMS) and non-MEMS applications), aesthetic structures (e.g., display of images on a piece of jewelry) and a variety of EMS devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art. For example, the teachings herein are applicable not only to interferometric MEMS display elements, but also to other EMS display elements such as those used in active-matrix liquid crystal display (AMLCD) and active-matrix organic light-emitting diode (AMOLED) display applications.

In certain implementations, active-matrix EMS devices including an integrated storage capacitor are provided. As used herein, the term “active-matrix” can refer to an EMS device in which each pixel of the device is individually controlled using an active switch, such as a thin film transistor (TFT). The EMS device can include an optical stack disposed over a substrate and a movable reflective membrane (i.e., mechanical layer) positioned over the optical stack to define a gap. The optical stack can include a stationary electrode and one or more dielectric layers. The mechanical layer is movable within the gap in response to a voltage applied between the mechanical layer and the stationary electrode. For example, a movable electrode can be formed from a portion of the mechanical layer and/or coupled to the mechanical layer, and a voltage difference between the movable electrode and the stationary electrode can be used to generate an electrostatic force that can move the mechanical layer. To improve electrical and/or optical performance, the EMS device can include an integrated storage capacitor and an active switch formed over an optically non-active region of the device. For example, including an integrated storage capacitor can increase a capacitance associated with a pixel, thereby reducing pixel leakage, reducing drive voltage and/or improving an image refresh of the display. The storage capacitor can include a first plate, a second plate and a dielectric structure disposed between the first and second plates. In some implementations, the first plate of the storage capacitor includes a portion of the mechanical layer and the dielectric structure includes at least one dielectric layer of the optical stack, thereby helping to integrate the design of the storage capacitor by forming the storage capacitor at least in part using layers used in forming pixels of the display. In some implementations, a support post used to support the mechanical layer is patterned so that a portion of the mechanical layer contacts the dielectric structure to form the first plate of the storage capacitor. The second plate of the storage capacitor can include any suitable electrical conductor, including, for example, the stationary electrode of the optical stack or a metal layer used to form a source and/or drain of a thin-film transistor.

Particular implementations of the subject matter described in this disclosure can be implemented to realize one or more of the following potential advantages. For example, some implementations reduce the drive voltage of a display and/or reduce the impacts of pixel leakage current relative to certain other configurations of displays, such as other active-matrix displays omitting a storage capacitor. Furthermore, some implementations improve an image refresh rate of a display. Moreover, some implementations improve integration of components of a display, thereby allowing the display to be fabricated using a smaller die area. Additionally, some implementations can be used to increase a capacitance associated with pixels of a display. Furthermore, some implementations can be used to reduce fabrication complexity by using layers used in forming pixels to form a storage capacitor. Additionally, some implementations can be used to reduce the power consumption of an array and/or otherwise improve the performance of the array.

An example of a suitable EMS or MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the IMOD. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

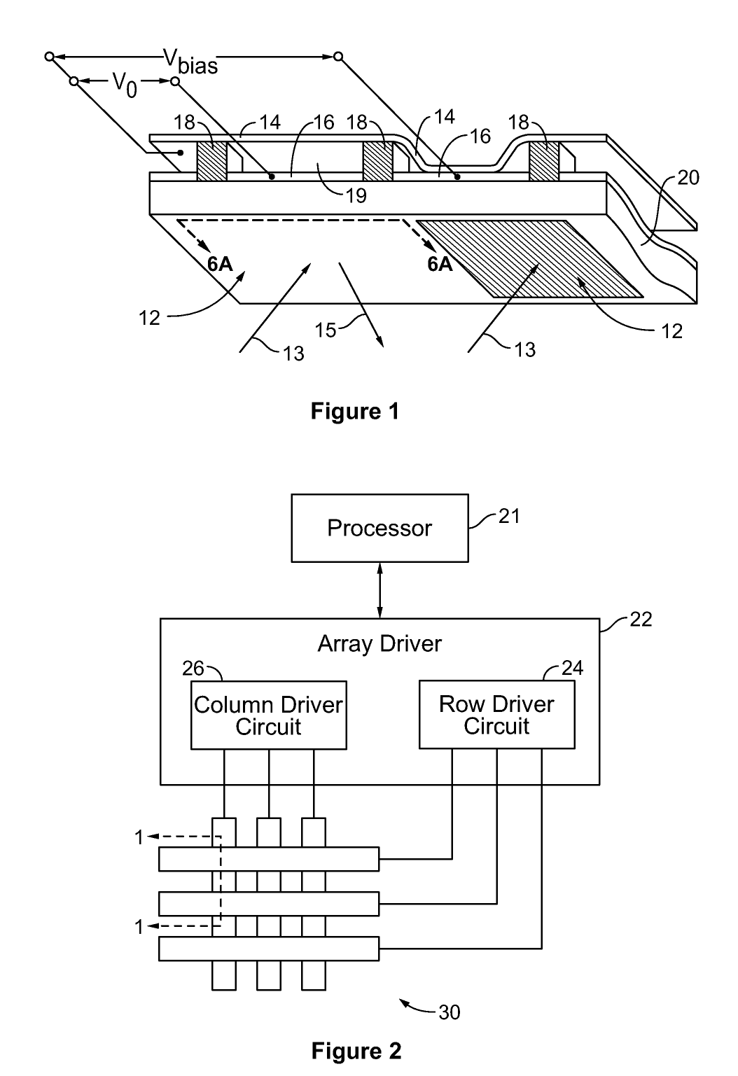

FIG. 1 shows an example of an isometric view depicting two adjacent pixels in a series of pixels of an IMOD display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when actuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent IMODs 12. In the IMOD 12 on the left (as illustrated), a movable reflective layer 14 is illustrated in a relaxed position at a predetermined distance from an optical stack 16, which includes a partially reflective layer. The voltage Vₒ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows indicating light 13 incident upon the pixels 12, and light 15 reflecting from the pixel 12 on the left. Although not illustrated in detail, it will be understood by one having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1,000 μm, while the gap 19 may be approximately 1-1,000 μm, while the gap 19 may be on the order of 1,000-10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 IMOD display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

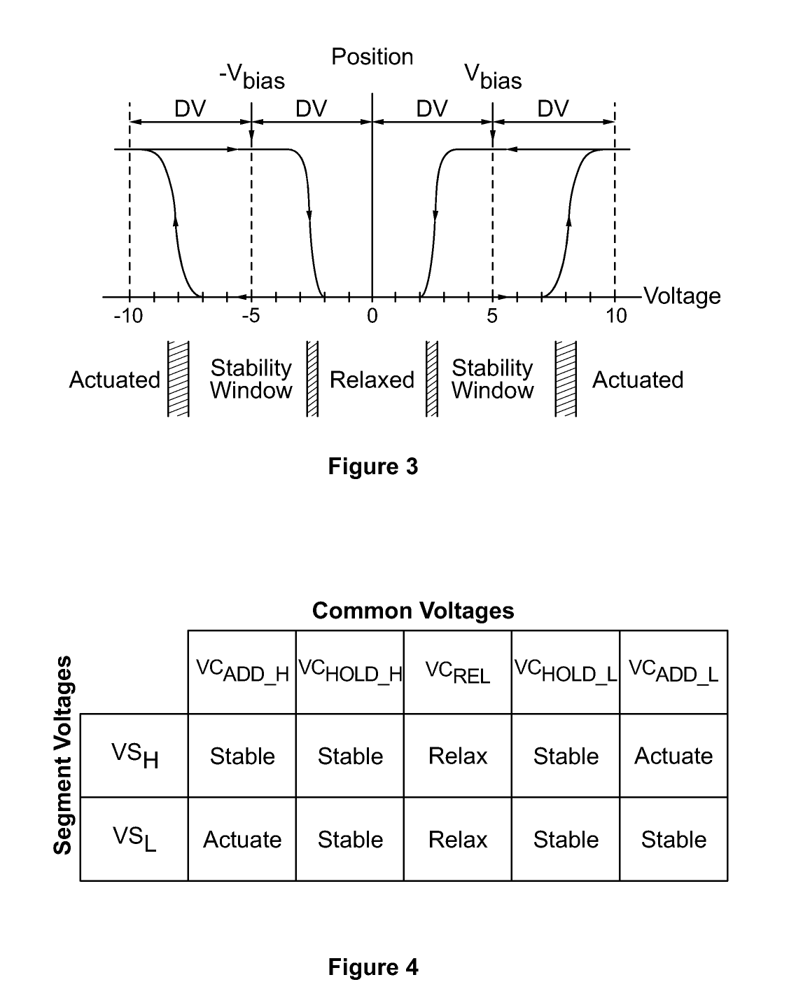

FIG. 3 shows an example of a diagram illustrating movable reflective layer position versus applied voltage for the IMOD of FIG. 1. For MEMS IMODs, the row/column (i.e., common/segment) write procedure may take advantage of a hysteresis property of these devices as illustrated in FIG. 3. An IMOD may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an IMOD when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

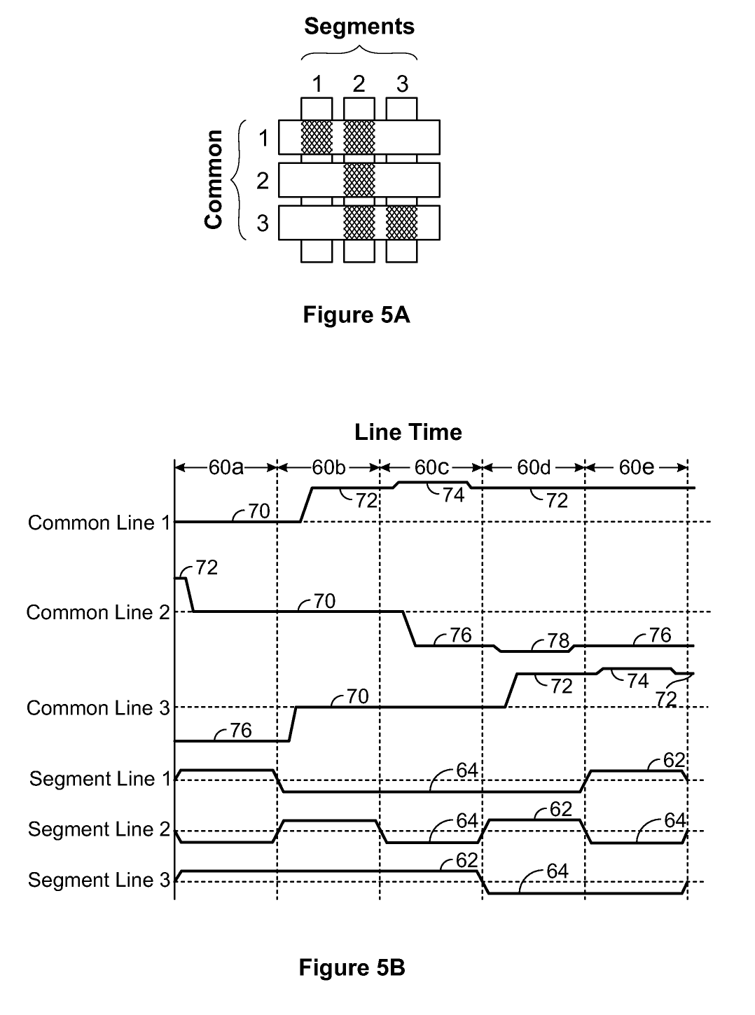

As illustrated in FIG. 4 (as well as in the timing diagram shown in FIG. 5B), when a release voltage VC_{REL} is applied along a common line, all IMOD elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the IMOD will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{DD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{DD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages and segment voltages may be used which produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 IMOD display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a, a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the IMODs, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

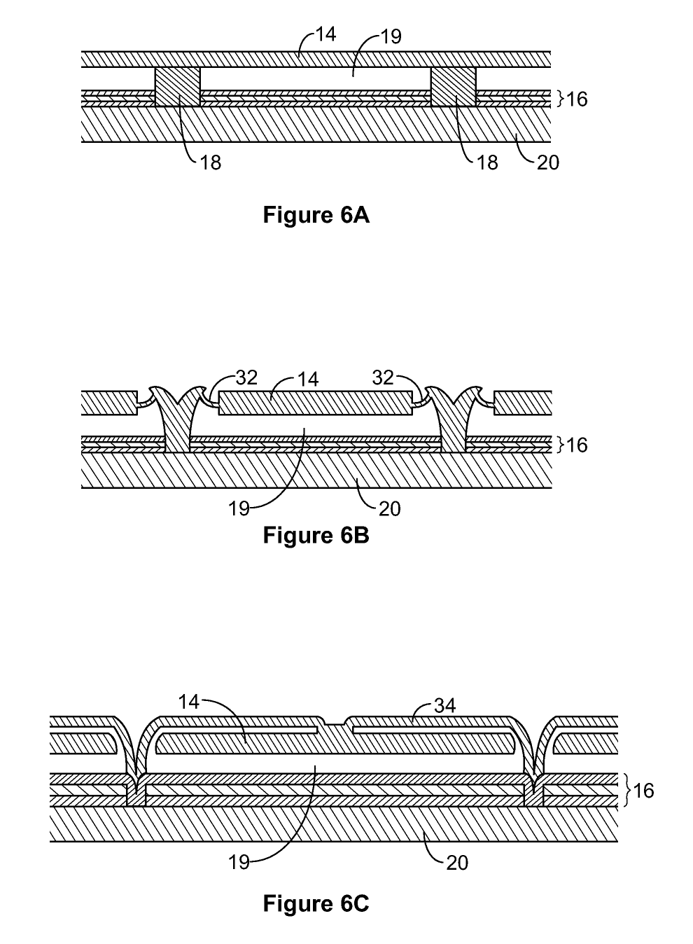

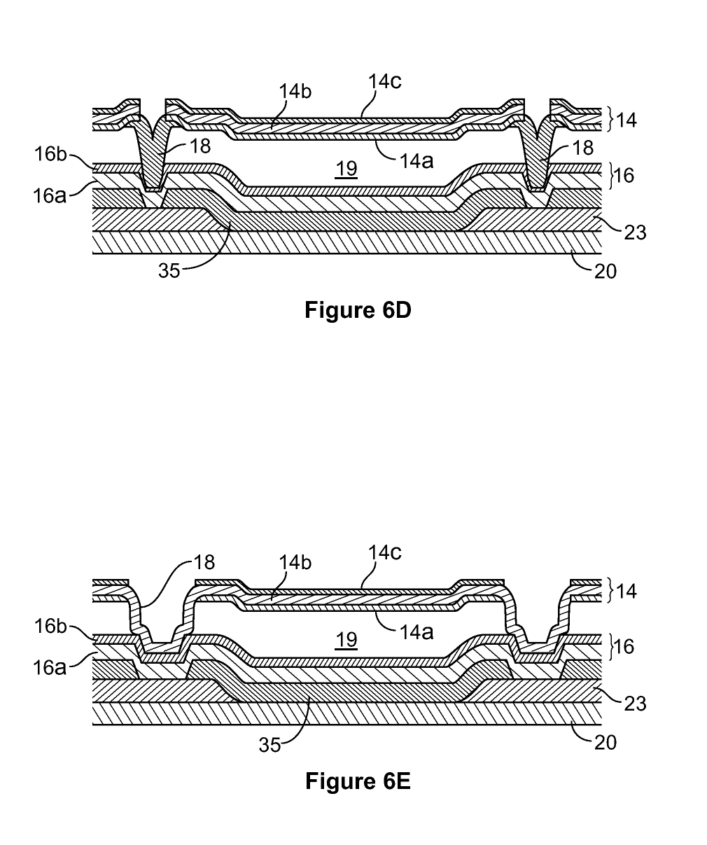

The details of the structure of IMODs that operate in accordance with the principles set forth above may vary widely. For example, FIGS. 6A-6E show examples of cross-sections of varying implementations of IMODs, including the movable reflective layer 14 and its supporting structures. FIG. 6A shows an example of a partial cross-section of the IMOD display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum alloy with about 0.5% copper (Cu), or another reflective metallic material. Employing conductive layers 14a and 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a SiO₂ layer, and an aluminum alloy that serves as a reflector and a bussing layer, with a thickness in the range of about 30-80 Å, 500-1,000 Å, and 500-6,000 Å, respectively. The one or more layers can be patterned using a variety of techniques, including photolithography and dry etching, including, for example, tetrafluoromethane (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the IMOD is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as patterning.

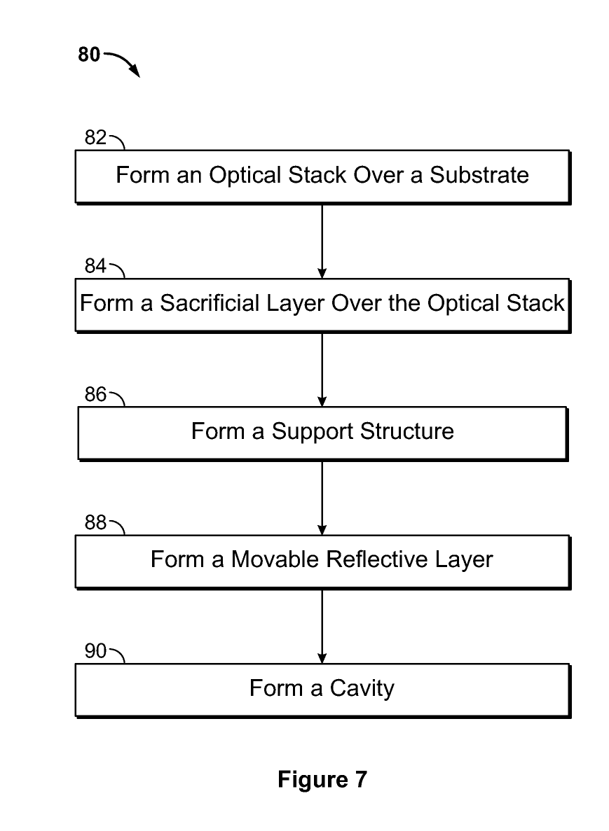

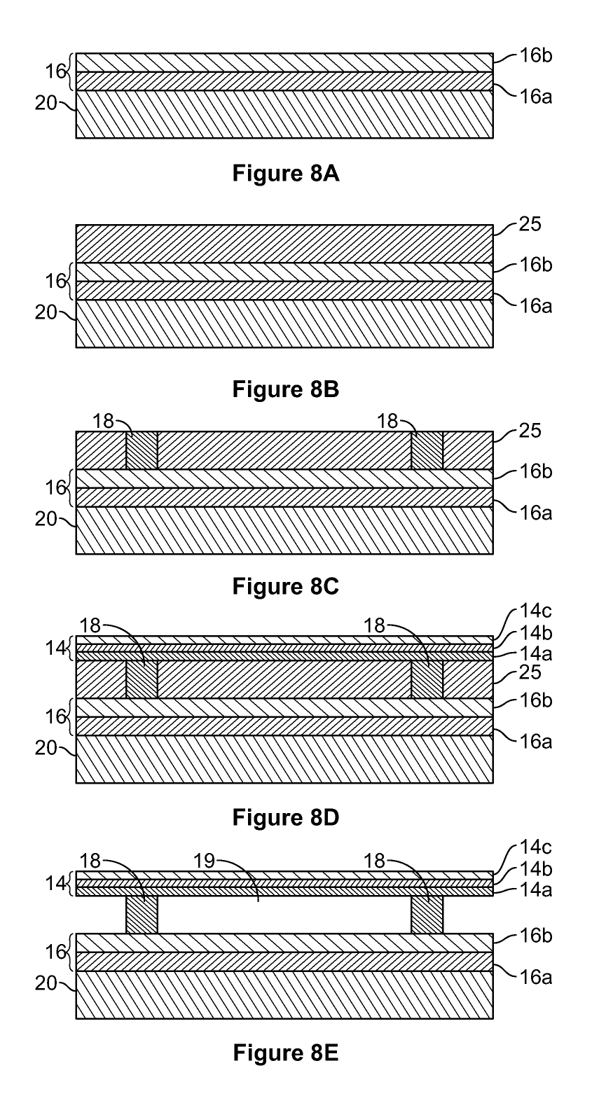

FIG. 7 shows an example of a flow diagram illustrating a manufacturing process 80 for an IMOD, and FIGS. 8A-8E show examples of cross-sectional schematic illustrations of corresponding stages of such a manufacturing process 80. In some implementations, the manufacturing process 80 can be implemented to manufacture, e.g., IMODs of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In the implementation illustrated in FIG. 8A, the optical stack 16 includes a multilayer structure having sub-layers 16a and 16b, although more or fewer sub-layers may be included in some other implementations. In some implementations, one of the sub-layers 16a and 16b can be configured with both optically absorptive and conductive properties, such as the combined conductor/absorber sub-layer 16a. Additionally, one or more of the sub-layers 16a and 16b can be patterned into parallel strips, and may form row electrodes in a display device. Such patterning can be performed by a masking and etching process or another suitable process known in the art. In some implementations, one of the sub-layers 16a and 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting IMODs 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or silicon (Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, and 14c as shown in FIG. 8D. In some implementations, one or more of the sub-layers, such as sub-layers 14a and 14c, may include highly reflective sub-layers selected for their optical properties, and another sub-layer 14b may include a mechanical sub-layer selected for its mechanical properties. Since the sacrificial layer 25 is still present in the partially fabricated IMOD formed at block 88, the movable reflective layer 14 is typically not movable at this stage. A partially fabricated IMOD that contains a sacrificial layer 25 also may be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous silicon (a-Si) may be removed by dry chemical etching, e.g., by exposing the sacrificial layer 25 to a gaseous or vaporous etchant, such as vapors derived from solid xenon difluoride (XeF₂) for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

In some implementations, an IMOD device including a mechanical layer and an integrated storage capacitor is provided. The IMOD device can be included in an active-matrix pixel array, and the storage capacitor can be used to improve the performance of the active-matrix pixel array. For example, the integrated storage capacitor can be used to increase a capacitance associated with the IMOD device, thereby improving an image refresh rate of the array, reducing a drive voltage of the array, reducing the power consumption of the array, and/or otherwise improving the performance of the array. The storage capacitor includes a first plate, a second plate, and a dielectric structure disposed between the first and second plates. In some implementations, the first plate of the storage capacitor is formed at least in part from a portion of a mechanical layer disposed over an optically non-active region of the IMOD device. The IMOD device can include an optical stack having a stationary electrode and one or more dielectric layers, and the dielectric structure of the storage capacitor can include at least one dielectric layer of the optical stack. The second plate of the storage capacitor can include any suitable electrical conductor, including, for example, the stationary electrode of the optical stack or a metal layer used to form a source and/or drain of a thin-film transistor.

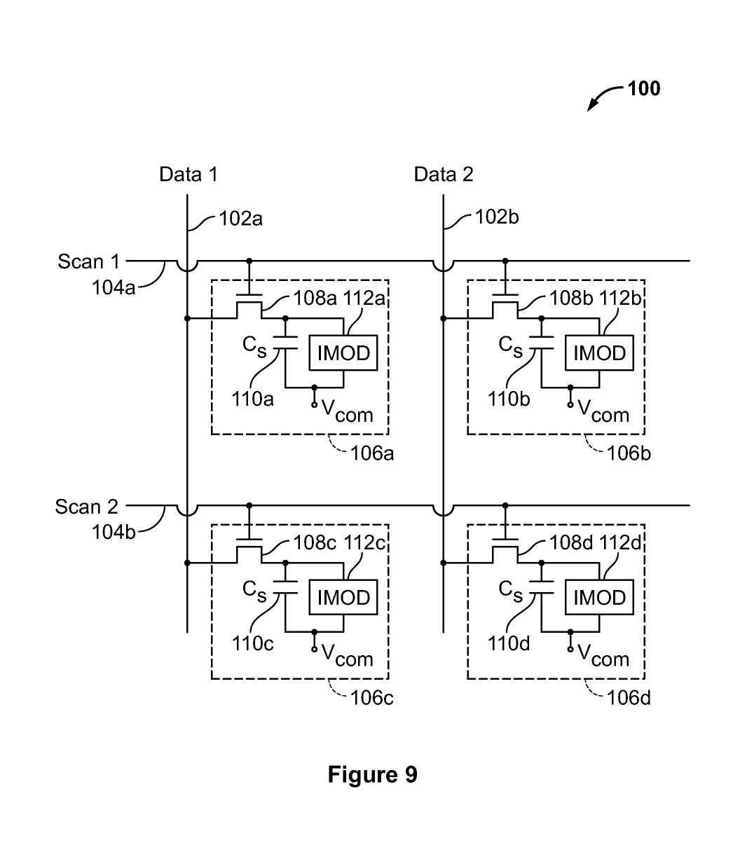

FIG. 9 shows a circuit diagram for one example of an active-matrix IMOD array 100. The illustrated IMOD array 100 includes a first data line 102a, a second data line 102b, a first scan line 104a, a second scan line 104b, a first pixel 106a, a second pixel 106b, a third pixel 106c and a fourth pixel 106d. Although the IMOD array 100 is illustrated as including four pixels for clarity of the illustration, implementations of the IMOD array 100 can include additional pixels, including, for example, pixels of different colors and/or hundreds or thousands, or even millions of pixels.

In the example illustrated in FIG. 9, each of the first to fourth pixels 106a, 106b, 106c and 106d includes a thin-film transistor (TFT), a storage capacitor and an IMOD. For example, the first pixel 106a includes a first TFT 108a, a first storage capacitor 110a and a first IMOD 112a. Similarly, the second pixel 106b includes a second TFT 108b, a second storage capacitor 110b and a second IMOD 112b. Likewise, the third pixel 106c includes a third TFT 108c, a third storage capacitor 110c and a third IMOD 112c. Furthermore, the fourth pixel 106d includes a fourth TFT 108d, a fourth storage capacitor 110d and a fourth IMOD 112d.

In this implementation, the first TFT 108a includes a source electrically coupled to the first data line 102a, a gate electrically coupled to the first scan line 104a and a drain electrically coupled to a first plate of the first storage capacitor 110a and to a first electrode of the first IMOD 112a. The second TFT 108b includes a source electrically coupled to the second data line 102b, a gate electrically coupled to the first scan line 104a and a drain electrically coupled to a first plate of the second storage capacitor 110b and to a first electrode of the second IMOD 112b. The third TFT 108c includes a source electrically coupled to the first data line 102a, a gate electrically coupled to the second scan line 104b and a drain electrically coupled to a first plate of the third storage capacitor 110c and to a first electrode of the third IMOD 112c. The fourth TFT 108d includes a source electrically coupled to the second data line 102b, a gate electrically coupled to the second scan line 104b and a drain electrically coupled to a first plate of the fourth storage capacitor 110d and to a first electrode of the fourth IMOD 112d. In the illustrated configuration, the first to fourth storage capacitors 110a, 110b, 110c and 110d each include a second plate electrically connected to a common voltage reference V_{COM}, which can be, for example, a ground voltage. However, other implementations are possible, such as configurations in which the second ends of the first and second capacitors 110a and 110b are electrically connected to a first common voltage reference and the second ends of the third and fourth capacitors 110c and 110d are electrically connected to a second common voltage reference. In the illustrated configuration, the first to fourth IMODs 112a, 112b, 112c and 112d each further include a second electrode electrically connected to the common voltage reference V_{COM}. However, other implementations are possible, such as configurations in which the second electrodes of the first and second IMODs 112a and 112b are electrically connected to a first common voltage reference and the second electrodes of the third and fourth IMODs 112c and 112d are electrically connected to a second common voltage reference, or configurations in which the second electrodes of the IMODs 112a, 112b, 112c and 112d are electrically connected to a first common voltage reference and the second plates of the capacitors 110a, 110b, 110c and 110d are electrically connected to a second common voltage reference. In some implementations, the first electrode of each of the first to fourth IMODs 112a, 112b, 112c and 112d is a movable electrode and the second electrode of each of the first to fourth IMODs 112a, 112b, 112c and 112d is a stationary electrode.

In some implementations, the storage capacitors 110a, 110b, 110c and 110d have a capacitance selected to be in the range of about 10 fF to about 1,000 fF, for example, about 60 ff. The capacitance of the storage capacitors 110a, 110b, 110c and 110d also can be selected relative to the capacitance of the IMODs 112a, 112b, 112c and 112d. For example, in some implementations, each storage capacitor has a capacitance that is about 1 times to about 3 times the capacitance of an associated IMOD. A person having ordinary skill in the art will readily understand that capacitance values can depend on many factors, such as air gap, pixel size, drive voltage requirement, power consumption, etc.

The first and second data lines 102a and 102b and the first and second scan lines 104a and 104b can be used to write image data to the IMOD array 100. For example, a signal provided on the first scan line 104a can be used to address a first row of the IMOD array 100 associated with the first and second pixels 106a and 106b. A signal provided on the second scan line 104b can be used to address a second row of the IMOD array 100 associated with the third and fourth pixels 106c and 106d. Additionally, the voltage provided to the first and second data lines 102a and 102b can be controlled so as to set the state of the IMODs in the selected row. For example, when addressing a given row, pixels in the addressed row that are to be actuated can be exposed to a voltage difference between the data line and the common voltage reference V_{COM} suitable for actuation, and pixels that are to be relaxed (or unactuated) can be exposed to a voltage difference between the data line and the common voltage reference V_{COM} suitable to cause the mechanical layer of the IMOD to be moved to a relaxed state. In some implementations, the actuation voltage is in the range of about 10 V to about 16 V, for example, about 12 V, and the relaxation voltage is in the range of about 0 V to about 8 V, for example, about 0 V or 1 V.

The inclusion of the first to fourth storage capacitors 110a, 110b, 110c and 110d can increase the amount of charge stored for a given amount of voltage across each IMOD. For example, the amount of charge stored on each of the IMODs 112a, 112b, 112c and 112d can be equal to about V_{IMOD}*(C_{IMOD}+C_{S}), where V_{IMOD} is the voltage difference between the first and second electrodes of the IMOD, C_{IMOD} is the capacitance of the IMOD, and C_{S} is the capacitance of the storage capacitor. Including the storage capacitors can increase pixel charge storage and can reduce the impacts of pixel leakage current. For example, charge leakage, such as leakage associated with channel leakage of a thin-film transistor (TFT), can cause the voltage of a pixel to change over time and can lead to a pixel changing state if it is not refreshed at a sufficiently fast rate or if the pixel does not have a sufficient amount of stored charge.

Accordingly, the first to fourth storage capacitors 110a, 110b, 110c and 110d can help prevent pixel leakage from changing the voltage across the electrodes of the first to fourth IMODs 112a, 112b, 112c and 112d over time, thereby improving image refresh rate and reducing drive voltage and power consumption of the pixel array 100. In some implementations, the integrated storage capacitors 110a, 110b, 110c and 110d are formed from one or more layers of the IMODs 112a, 112b, 112c and 112d. Using layers of the IMODs 112a, 112b, 112c and 112d to form the storage capacitors in all or part can help integrate the design of the pixel array 100, thereby reducing the area (or footprint) of the array. Although the pixel array 100 illustrates one configuration suitable for using the storage capacitors 110a, 110b, 110c and 110d, integrated storage capacitors can be used in any suitable pixel array, including, for example, other implementations of active or analog IMOD arrays.

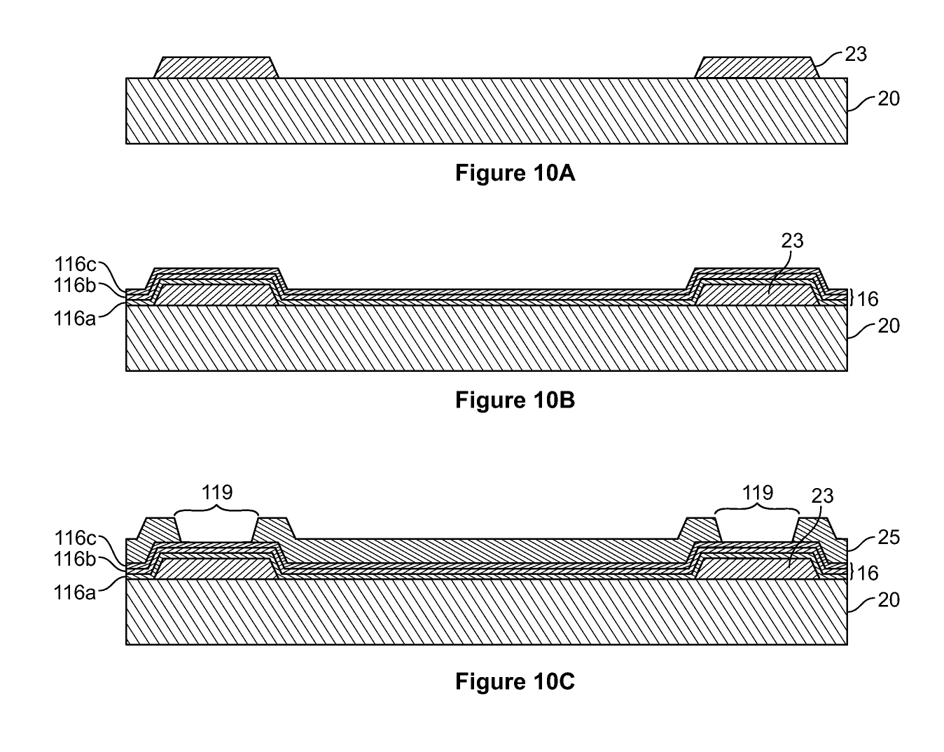

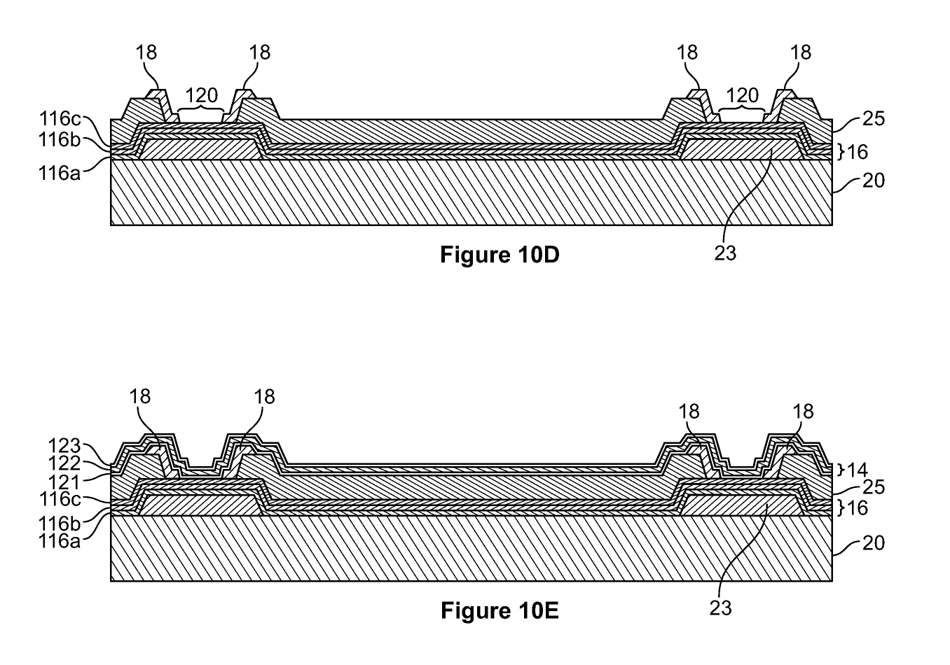

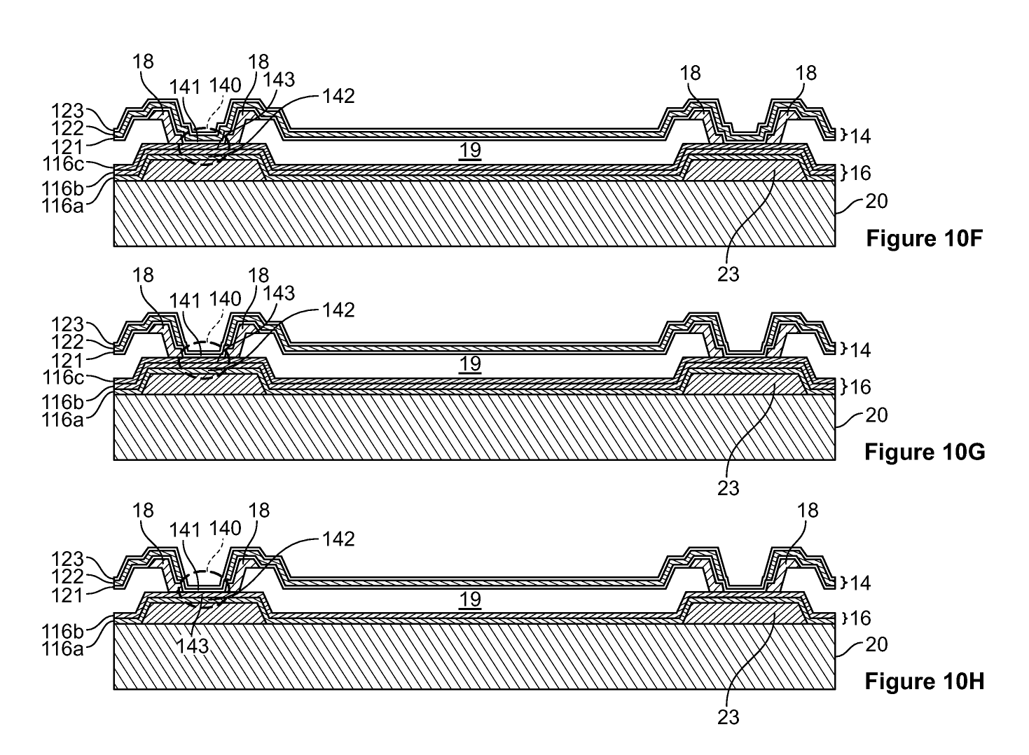

FIGS. 10A-10H show examples of cross-sectional schematic illustrations of various stages in methods of making active-matrix IMODs according to various implementations. While particular parts and steps are described as suitable for fabricating certain implementations of IMODs, for other implementations, different parts and steps, and materials can be used, or parts can be modified, omitted, or added.

In FIG. 10A, a black mask structure 23 has been provided and patterned on a substrate 20. The substrate 20 can include a variety of materials, including glass, plastic or any transparent polymeric material which permits images to be viewed through the substrate 20. The black mask structure 23 can be configured to absorb ambient or stray light in optically inactive regions (such as beneath supports or between pixels) to improve the optical properties of the IMOD by increasing the contrast ratio. Additionally, the black mask structure 23 can be conductive and configured to function as an electrical bussing layer. The black mask structure 23 can be formed using a variety of methods, including deposition and patterning techniques.

Although FIGS. 10A-10H are shown as including the black mask structure 23, persons having ordinary skill in the art will recognize that this is for illustrative purposes of this implementation, and that integrated storage capacitors also can be included in EMS devices lacking the black mask structure 23.

FIG. 10B illustrates providing an optical stack 16 over the substrate 20 and the black mask 23. The optical stack 16 can include several layers, including, for example, one or more dielectric layers. In the illustrated configuration, the optical stack 16 includes a stationary electrode 116a disposed over the substrate 20, a first dielectric layer 116b disposed over the stationary electrode 116a and a second dielectric layer 116c disposed over the first dielectric layer 116b. In some implementations, the stationary electrode 116a can include a transparent conductor, such as indium tin oxide (ITO) and/or MoCr the first dielectric layer 116b can include SiO₂ and/or SiON, and the second dielectric layer 116c can include aluminum oxide (Al₂O₃). Although the optical stack 16 includes two dielectric layers in the configuration shown in FIG. 10C, in certain implementations, the optical stack 16 can include more or fewer dielectric layers and/or can be modified to include additional layers. As illustrated in FIG. 10C, one or more layers of the optical stack 16 may physically and electrically contact the black mask structure 23.

In some implementations, the first dielectric layer 116b is selected to have a thickness in the range of about 10 nm to about 70 nm, for example, about 30 nm, and the second dielectric layer 116c is selected to have a thickness in the range of about 4 nm to about 20 nm, for example, about 15 nm. However, a person having ordinary skill in the art will readily understand that the thicknesses of the first and second dielectric layers 116b and 116c can depend on many factors, including, for example, on a desired capacitance of an integrated storage capacitor and/or on manufacturing constraints. As will be described later below, the first and/or second dielectric layers 116b and 116c can be included in a dielectric structure of an integrated storage capacitor. Since the capacitance of the integrated storage capacitor can be inversely proportional to a separation between the plates of the storage capacitor, selecting the first and/or second dielectric layers 116b and 116c to be relatively thin can increase the capacitance of the integrated storage capacitor.

FIG. 10C illustrates providing and patterning a sacrificial layer 25 over the optical stack 16. The sacrificial layer 25 is typically later removed to form a gap. The formation of the sacrificial layer 25 over the optical stack 16 can include deposition of a fluorine-etchable material such as Mo or a-Si. Additionally, the sacrificial layer 25 can be selected to include more than one layer, or include a layer of varying thickness, to aid in the formation of a display device having a multitude of resonant optical gaps. For an IMOD array, each gap size can represent a different reflected color. Moreover, in some implementations, multiple layers of different functions can be provided, over or between sacrificial layers. As illustrated in FIG. 10C, the sacrificial layer 25 may be patterned over the black mask structure 23 to form support structure apertures 119 that can be used to form support structures, such as support posts.

FIG. 10D illustrates providing and patterning a support layer to form support structures 18. The support structures 18 can be used to support a subsequently deposited mechanical layer, as will be described below. The support structures 18 can include, for example, SiO₂ and/or SiON. The support layer can be deposited over the sacrificial layer 25 and the support structure apertures 119 using any suitable technique, such as PECVD, thermal CVD, or spin-coating. Thereafter, the support layer can be patterned to form the support structures 18, such as by using a dry etch including CF₄.

When forming an integrated storage capacitor, a portion of the support layer used to form the support structures 18 can be patterned over an optically non-active region of the IMOD. For example, as shown in FIG. 10D, the storage capacitors apertures 120 for forming storage capacitors have been patterned in the support layer above a portion of the black mask structure 23. Patterning the support layer to form the storage capacitor apertures 120 allows a subsequently deposited mechanical layer to contact the optical stack 16, as will be described in detail below. In some implementations, the storage capacitors apertures 120 include a region having an area of at least about 8 square μm. However, a person having ordinary skill in the art will readily understand that the area of the storage capacitors apertures 120 can depend on many factors, including, for example, on a desired capacitance of an integrated storage capacitor.

Reference will now be made to FIGS. 10E and 10F. FIG. 10E illustrates providing and patterning a movable or mechanical layer 14 over the sacrificial layer 25. The mechanical layer 14 includes a reflective or mirror layer 121, a dielectric layer 122 and a cap or conductive layer 123. FIG. 10F illustrates the IMOD after removal of the sacrificial layer 25 of FIG. 10E to form a gap 19.

The mirror layer 121 can be any suitable reflective material, including, for example, a metal, such as an aluminum alloy. In some implementations, the mirror layer 121 includes aluminum-copper (AlCu) having copper by weight in the range of about 0.3% to 1.0%, for example, about 0.5%. The thickness of the mirror layer 121 can be any suitable thickness, such as a thickness in the range of about 200-500 Å, for example, about 300 Å.

The dielectric layer 122 can be a dielectric layer of, for example, SiON, and the dielectric layer 122 can have any suitable thickness, such as a thickness in the range of about 500-8,000 Å. However, the thickness of the dielectric layer 122 can be selected depending on a variety of factors, including, for example, the desired stiffness of the dielectric layer 122, which can aid in achieving the same pixel actuation voltage for different sized air-gaps for color display applications.

As illustrated in FIG. 10E, the cap or conductive layer 123 can be provided conformally over the dielectric layer 122. The conductive layer 123 can be a metallic material including, for example, the same aluminum alloy as the mirror layer 121. In one implementation, the conductive layer 123 includes AlCu having copper by weight in the range of about 0.3% to 1.0%, for example, about 0.5%, and the thickness of the conductive layer 123 is selected to be in the range of about 200-500 Å, for example, about 300 Å. The mirror layer 121 and the conductive layer 123 can be selected to have similar thickness and composition, thereby aiding in balancing stresses in the mechanical layer and improving mirror flatness by reducing sensitivity of gap height to temperature.

The sacrificial layer 25 can be removed using a variety of methods, such as by exposing the sacrificial layer 25 to an etchant. For example, an etchable sacrificial material 25 such as Mo, tungsten (W), tantalum (Ta) or polycrystalline or amorphous Si may be removed by dry chemical etching, for example, by exposing the sacrificial layer to a fluorine-based gaseous or vaporous etchant, such as vapors derived from XeF₂. As skilled artisans will recognize, the sacrificial layer can be exposed for a period of time that is effective to remove the material, typically selectively relative to the structures surrounding the gap. Other selective etching methods, for example, wet etching and/or plasma etching, also can be used.

The IMOD of FIG. 10F includes an integrated storage capacitor 140. The integrated storage capacitor 140 is formed above the black mask structure 23, and includes a first plate 141, a second plate 142 and a dielectric structure 143. In the illustrated configuration, the first plate 141 includes a portion of the reflective layer 121, the second plate 142 includes a portion of the stationary electrode 116a, and the dielectric structure includes a portion of the first and second dielectric layers 116b and 116c of the optical stack 16. The integrated storage capacitor 140 is formed using layers that serve other functions in the IMOD. Using layers that serve other functions to form the integrated storage capacitor 140 can reduce manufacturing costs of the storage capacitor 140 relative to a design in which the storage capacitor 140 is formed using additional mask layers.

The illustrated storage capacitor 140 is disposed in an optically non-active region of the IMOD. For example, in the illustrated configuration, the storage capacitor 140 has been formed over the black mask 23 in the storage capacitor aperture 120 of FIG. 10D. Forming the storage capacitor 140 in the storage capacitor aperture 120 allows the portion of the mechanical layer 14 that forms the first plate 141 of the storage capacitor 140 to contact the dielectric layer 116c of the optical stack 16, thereby reducing a separation between the first and second plates 141 and 142 and increasing the capacitance of the storage capacitor 140. In the configuration shown in FIG. 10F, the stationary electrode 116a extends beneath the storage capacitor aperture 120 of FIG. 10D to define the second plate 142 of the storage capacitor 140. However, the second plate 142 of the capacitor 140 can be formed from any suitable conductive layer, including, for example, a conductive layer associated with a source or drain of a thin-film transistor (TFT).

FIG. 10G illustrates an IMOD according to another implementation. The IMOD of FIG. 10G is similar to the IMOD of FIG. 10F, except the IMOD of FIG. 10G includes a different arrangement for the first plate 141 of the storage capacitor 140. For example, the dielectric layer 122 of the mechanical layer 14 has been patterned over the storage capacitor aperture 120 of FIG. 10D such that the reflective layer 121 contacts the cap layer 123 in the portion of the mechanical layer 14 that forms the first plate 141 of the storage capacitor 140. Patterning the dielectric layer 122 of the mechanical layer 14 in this manner can reduce the electrical resistance of the storage capacitor 140, thereby reducing a time delay associated with charging or discharging the storage capacitor 140.

FIG. 10H illustrates an IMOD according to another implementation. The IMOD of FIG. 10H is similar to the IMOD of FIG. 10G, except the IMOD of FIG. 10H includes a different arrangement for the dielectric structure 143 of the storage capacitor 140. For example, the dielectric structure 143 of the storage capacitor 140 includes only the first dielectric layer 116b of the optical stack 16. In some implementations, the dielectric structure 143 of the storage capacitor 140 can include only a single layer of the optical stack 16.

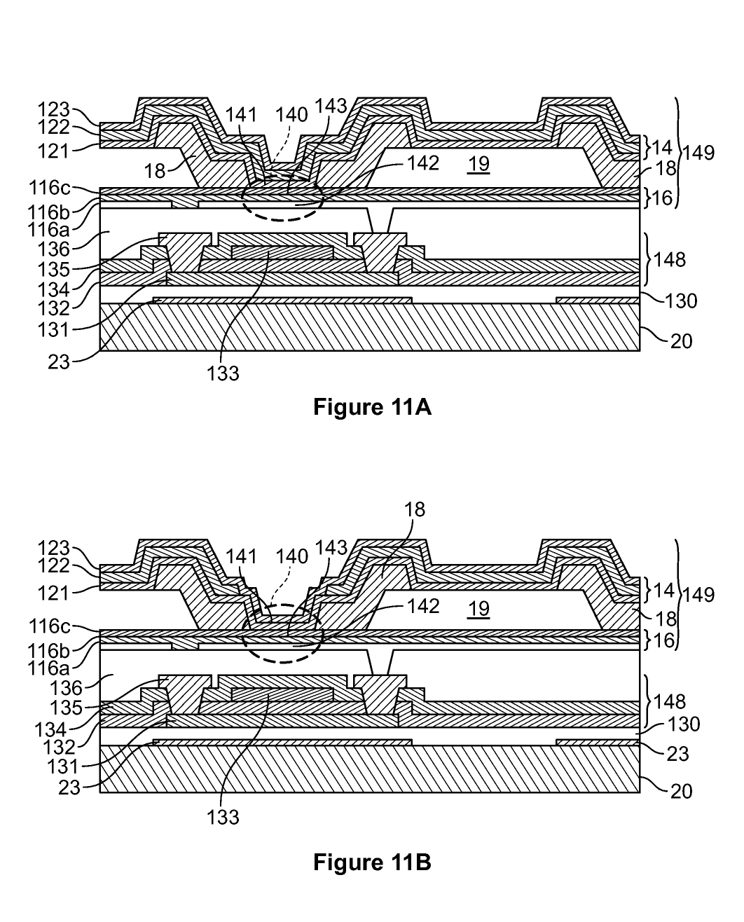

FIGS. 11A and 11B show examples of cross-sectional schematic illustrations of varying implementations of active-matrix electromechanical systems (EMS) devices.

FIG. 11A illustrates an electromechanical device according to one implementation. The illustrated EMS device includes a substrate 20, a black mask 23, a buffer layer 130, an active layer 131, a gate dielectric layer 132, a gate layer 133, a spacer dielectric layer 134, a source/drain conductive layer 135, a planarization layer 136, an optical stack 16, support structures 18 and a mechanical layer 14. The optical stack 16 includes a stationary electrode 116a, a first dielectric layer 116b and a second dielectric layer 116c, and the mechanical layer 14 includes a mirror layer 121, a dielectric layer 122 and a cap or conductive layer 123.

The illustrated EMS device includes a storage capacitor 140, a TFT 148, and an IMOD 149. Integrating the storage capacitor 140, the TFT 148, and the IMOD 149 together can reduce the area of a pixel array, such as the pixel array 100 of FIG. 9.

The EMS device of FIG. 11A includes the black mask 23 formed over the substrate 20. To help form the TFT 148 over the black mask 23, a planarized buffer layer 130 has been provided over the black mask 23 and the substrate 20. In some implementations, the buffer layer 130 can include a dielectric, such as SiO₂. The active layer 131 has been formed over the buffer layer 130, and can be doped to form a channel region of the TFT 148. In some implementations, the active layer 131 includes Si. The gate dielectric layer 132 and gate layer 133 have been provided over the active layer 131 to form a gate of the TFT 148. In some implementations, the gate dielectric layer 132 and the gate layer 133 can include SiO₂ and polysilicon (poly-Si), respectively. The spacer dielectric layer 134 is formed over the gate layer 133, and can electrically isolate the gate layer 133 from other layers and to protect the gate layer 133 during processing. In some implementations, the spacer dielectric layer 134 includes SiO₂.

As shown in FIG. 11A, the source/drain layer or transistor contact layer 135 can be provided over the spacer dielectric layer 134, and can contact portions of the active layer 131 to provide electrical connections to the source and drain of the TFT 148. The source/drain layer 135 can be, for example, any suitable metal. The planarization layer 136 has been formed over the TFT 148, and can be used as a surface over which the IMOD 149 and the storage capacitor 140 can be formed. In some implementations, the planarization layer 136 includes SiO₂. Although the EMS device of FIG. 11A is illustrated as including the planarization layer 136, in some implementations the planarization layer can be omitted.

The optical stack 16 has been formed over the planarization layer 136. The illustrated optical stack 16 includes the stationary electrode 116a, the first dielectric layer 116b and the second dielectric layer 116c. As shown in FIG. 11A, portions of the planarization layer 136 can be patterned before depositing the optical stack 16 so as to allow the optical stack 16 to contact the one or more layers underlying the planarization layer 136. For example, the planarization layer 136 can be patterned such that the stationary electrode 116a contacts the source/drain layer 135, thereby electrically connecting the IMOD 149 and the storage capacitor 140 to the TFT 148. The support structures 18, the mechanical layer 14 and the integrated storage capacitor 140 can be provided over the optical stack 16, and can be used form the IMOD 149 and the storage capacitor 140 as was described above with respect to FIGS. 10A-10H.

The integrated storage capacitor 140 includes a first plate 141, a second plate 142 and a dielectric structure 143. In the illustrated configuration, the first plate 141 includes a portion of the reflective layer 121, the second plate 142 includes a portion of the stationary electrode 116a, and the dielectric structure 143 includes a portion of the first and second dielectric layers 116b and 116c of the optical stack 16.

FIG. 11B illustrates an EMS device according to another implementation. The EMS device of FIG. 11B is similar to the EMS device of FIG. 11A, except the EMS device of FIG. 11B includes a different arrangement for the first plate 141 of the storage capacitor 140. For example, the dielectric layer 122 of the mechanical layer 14 has been patterned such that the reflective layer 121 contacts the cap layer 123 in the portion of the mechanical layer 14 that forms the first plate 141 of the storage capacitor 140. Patterning the dielectric layer 122 of the mechanical layer 14 in this manner can reduce the electrical resistance of the storage capacitor 140, thereby reducing a time delay associated with charging or discharging the storage capacitor 140.

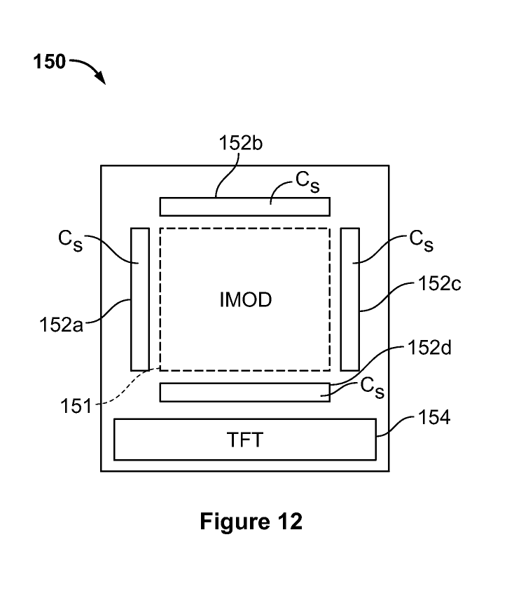

FIG. 12 shows a schematic plan view of one example of an active-matrix EMS device 150. The illustrated EMS device 150 includes an IMOD 151, first to fourth storage capacitor segments 152a, 152b, 152c and 152d, and a thin-film transistor (TFT) 154. While this example illustrates four capacitor storage segments 152a, 152b, 152c and 152d disposed along each side of the IMOD 151, other implementations can have fewer storage capacitor segments, or the storage capacitor segments can be arranged or aligned differently.

The IMOD 151 includes a first side, a second side, a third side and a fourth side, and the first to fourth capacitor segments 152a, 152b, 152c and 152d have been formed adjacent the first to fourth sides of the IMOD 151, respectively. The TFT 154 is formed adjacent the fourth capacitor segment 152d on a side of the fourth capacitor segment 152d opposite the IMOD 151. The first to fourth storage capacitors segments 152a, 152b, 152c and 152d can be electrically coupled together to form a storage capacitor. In some implementations, the total area of all of the storage capacitor segments 152a, 152b, 152c and 152d is selected to be in the range of about 8 square μm to about 100 square μm, for example, about 20 square μm. However, a person having ordinary skill in the art will readily understand that the total area of the storage capacitor segments 152a, 152b, 152c and 152d can depend on many factors, including, for example, on a desired capacitance of an integrated storage capacitor.

As shown in FIG. 12, in some implementations a TFT or other active switch can be formed on a substrate adjacent a storage capacitor. However, in some other implementations, such as in the implementations shown in FIGS. 11A-11B, at least a portion of the storage capacitor can be formed over the TFT such that the storage capacitor and the TFT overlap when viewed from above.

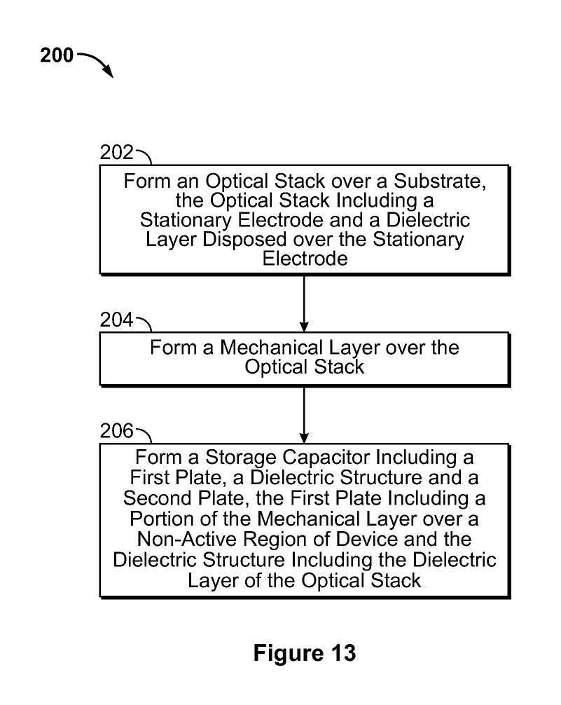

FIG. 13 shows an example of a flow diagram illustrating a manufacturing process 200 for an active-matrix EMS device.

In block 202, an optical stack is formed over a substrate. The optical stack includes a stationary electrode and at least one dielectric layer disposed over the stationary electrode.

The process 200 continues at a block 204, in which a mechanical layer is formed over the optical stack. In some implementations, the mechanical layer includes a reflective layer, a dielectric layer and a cap layer.

In block 206, a storage capacitor including a first plate, a second plate and a dielectric structure is formed over an optically non-active region of the EMS device. The first plate includes a portion of the mechanical layer and the dielectric structure includes a portion of the dielectric layer of the optical stack. In some implementations, the dielectric layer of the mechanical layer is patterned over the storage capacitor such that the first plate of the storage capacitor includes both a portion of the reflective layer and a portion of the cap layer of the mechanical layer. Many additional steps may be employed before, in the middle of, or after the illustrated sequence, but such steps are omitted here for clarity of the description.

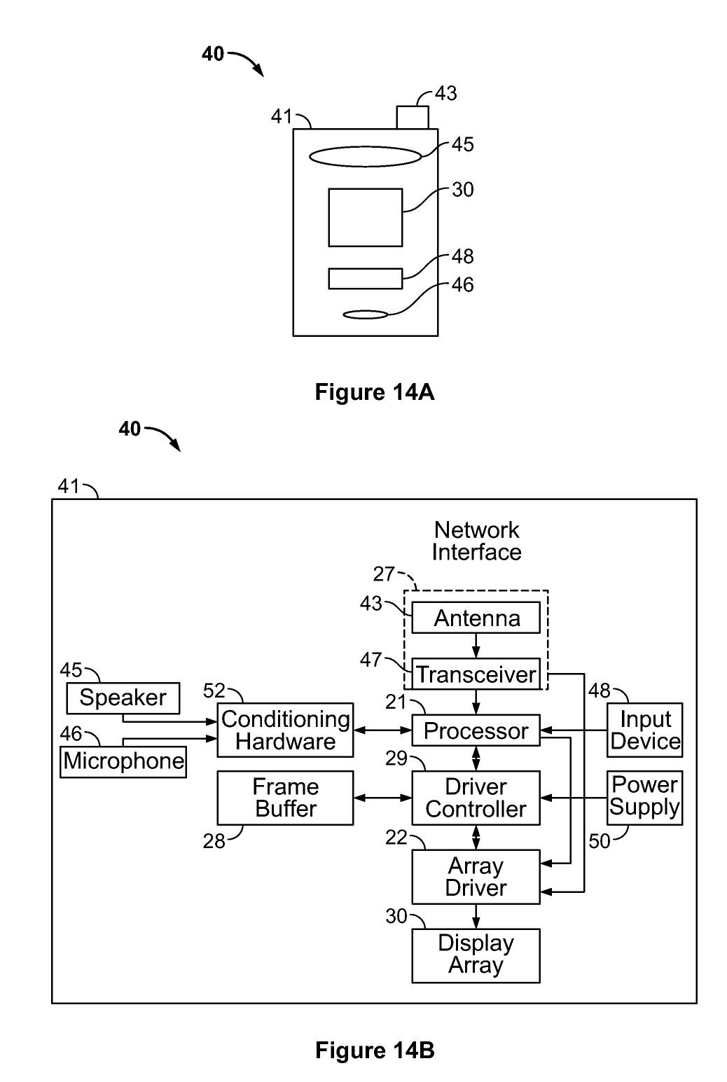

FIGS. 14A and 14B show examples of system block diagrams illustrating a display device 40 that includes a plurality of IMODs. The display device 40 can be, for example, a smart phone, a cellular or mobile telephone. However, the same components of the display device 40 or slight variations thereof are also illustrative of various types of display devices such as televisions, tablets, e-readers, hand-held devices and portable media players.

The display device 40 includes a housing 41, a display 30, an antenna 43, a speaker 45, an input device 48 and a microphone 46. The housing 41 can be formed from any of a variety of manufacturing processes, including injection molding and vacuum forming. In addition, the housing 41 may be made from any of a variety of materials, including, but not limited to: plastic, metal, glass, rubber and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an IMOD display, as described herein.

The components of the display device 40 are schematically illustrated in FIG. 14B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. In some implementations, a power supply 50 can provide power to substantially all components in the particular display device 40 design.

The network interface 27 includes the antenna 43 and the transceiver 47 so that the display device 40 can communicate with one or more devices over a network. The network interface 27 also may have some processing capabilities to relieve, for example, data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g, n, and further implementations thereof. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), NEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, in some implementations, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (such as an IMOD controller). Additionally, the array driver 22 can be a conventional driver or a bi-stable display driver (such as an IMOD display driver). Moreover, the display array 30 can be a conventional display array or a bi-stable display array (such as a display including an array of IMODs). In some implementations, the driver controller 29 can be integrated with the array driver 22. Such an implementation can be useful in highly integrated systems, for example, mobile phones, portable-electronic devices, watches or small-area displays.

In some implementations, the input device 48 can be configured to allow, for example, a user to control the operation of the display device 40. The input device 48 can include a keypad, such as a QWERTY keyboard or a telephone keypad, a button, a switch, a rocker, a touch-sensitive screen, a touch-sensitive screen integrated with the display array 30, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices. For example, the power supply 50 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An electromechanical systems (EMS) device, comprising:
a substrate;
an optical stack disposed over the substrate, the optical stack including a stationary electrode and at least one dielectric layer disposed over the stationary electrode;
a movable layer positioned over the optical stack to define a cavity between the movable layer and the optical stack, the movable layer movable through the cavity between an actuated position and a relaxed position; and
a storage capacitor including a first plate, a second plate and a dielectric structure disposed between the first and second plates, wherein the first plate includes a portion of the movable layer positioned over an optically non-active region of the device, and wherein the dielectric structure of the storage capacitor includes a portion of the at least one dielectric layer of the optical stack.

2. The device of claim 1, wherein the portion of the movable layer that forms the first plate of the capacitor contacts the at least one dielectric layer of the optical stack over the optically non-active region of the device.

3. The device of claim 2, further comprising a support structure over the substrate for supporting the movable layer, wherein at least a portion of the support structure over the optically non-active region of the device is patterned such that the portion of the movable layer that forms the first plate of the capacitor contacts the at least one dielectric layer of the optical stack in the patterned portion.

4. The device of claim 3, wherein the patterned portion of the support structure includes a region of at least about 8 square μm where the portion of the movable layer that forms the first plate of the capacitor contacts the at least one dielectric layer of the optical stack.

5. The device of claim 1, wherein the stationary electrode extends beneath the patterned portion of the support structure to define the second plate of the capacitor.

6. The device of claim 1, further comprising a thin-film transistor (TFT) disposed over the substrate adjacent the storage capacitor.

7. The device of claim 1, further comprising a thin-film transistor (TFT) disposed on the substrate, wherein the optical stack, the movable layer and the storage capacitor are disposed over the TFT.

8. The device of claim 1, wherein the movable layer includes a reflective layer, a dielectric layer, and a cap layer, the dielectric layer disposed between the reflective layer and the cap layer, wherein the portion of the movable layer that forms the first plate includes the reflective layer.

9. The device of claim 8, wherein the cap layer contacts the reflective layer in the portion of the movable layer that forms the first plate.

10. The device of claim 1, wherein the at least one dielectric layer of the optical stack includes a silicon dioxide (SiO₂) layer disposed over the stationary electrode.

11. The device of claim 10, wherein the at least one dielectric layer of the optical stack further includes an aluminum oxide (Al₂O₃) layer disposed over the SiO₂ layer.

12. The device of claim 1, wherein the at least one dielectric layer of the optical stack further includes a plurality of dielectric layers, and wherein the dielectric structure of the storage capacitor includes a portion of each of the plurality of dielectric layers.

13. The device of claim 1, further comprising a bias circuit configured to apply a bias voltage across the stationary electrode and the movable layer, wherein the device is configured such that when the bias voltage is applied at least a portion of the movable layer is positioned substantially parallel to the substrate.

14. The device of claim 13, further comprising:
a display;
a processor that is configured to communicate with the display, the processor being configured to process image data; and
a memory device that is configured to communicate with the processor.

15. The device of claim 14, further comprising:
a driver circuit configured to send at least one signal to the display; and
a controller configured to send at least a portion of the image data to the driver circuit.

16. The device of claim 15, further comprising an image source module configured to send the image data to the processor, wherein the image source module comprises at least one of a receiver, transceiver, and transmitter.

17. The device of claim 15, further comprising an input device configured to receive input data and to communicate the input data to the processor.

18. A method of forming an electromechanical systems (EMS) device having an actuated position and a relaxed position, comprising:
forming an optical stack over a substrate, the optical stack including a stationary electrode and at least one dielectric layer disposed over the stationary electrode;
forming a movable layer over the optical stack; and
forming a storage capacitor including a first plate, a second plate and a dielectric structure disposed between the first and second plates, wherein a portion of the movable layer over an optically non-active region of the device is arranged to form the first plate of the capacitor, and wherein the at least one dielectric structure of the optical stack is arranged to form the dielectric layer of the capacitor.

19. The method of claim 18, further comprising attaching the portion of the movable layer that forms the first plate of the capacitor to the at least one dielectric layer of the optical stack over the optically non-active region of the device.

20. The method of claim 19, further comprising:
forming a support structure over the substrate for supporting the movable layer; and
patterning a portion of the support structure over the optically non-active region of the device,
wherein forming the movable layer includes forming the movable layer over the patterned portion of the support structure such that the portion of the movable layer that forms the first plate of the capacitor contacts the at least one dielectric layer of the optical stack.

21. The method of claim 20, wherein forming the optical stack includes forming the stationary electrode to extend beneath the patterned portion of the support structure to define the second plate of the capacitor.

22. The method of claim 18, wherein the movable layer includes a reflective layer, a dielectric layer, and a cap layer, the dielectric layer disposed between the reflective layer and the cap layer, wherein the portion of the movable layer that forms the first plate includes the reflective layer.

23. The method of claim 22, further comprising patterning the dielectric layer of the movable layer such that the cap layer contacts the reflective layer in the portion of the mechanical layer that forms the first plate.

24. An electromechanical systems (EMS) device, comprising:
a substrate;
an optical stack disposed over the substrate, the optical stack including a stationary electrode and at least one dielectric layer disposed over the stationary electrode;
a movable layer positioned over the optical stack to define a cavity between the movable layer and the optical stack, the movable layer movable through the cavity between an actuated position and a relaxed position; and
a means for storing charge including a first plate, a second plate and a dielectric structure disposed between the first and second plates, wherein the storing charge means is disposed in an optically non-active region of the device, and wherein the storing charge means includes a portion of the movable layer and a portion of the at least one dielectric layer.

25. The device of claim 24, wherein the portion of the movable layer that forms the first plate of the charge storing means contacts the at least one dielectric layer of the optical stack over the optically non-active region of the device.

26. The device of claim 24, further comprising a support structure over the substrate for supporting the movable layer, wherein a portion of the support structure over the optically non-active region of the device is patterned such that the portion of the movable layer that forms the first plate of the charge storing means contacts the at least one dielectric layer of the optical stack in the patterned portion.

27. The device of claim 24, wherein the charge storing means has a capacitance in the range of 10 fF to about 1,000 fF.
